(19) United States
(12) Patent Application Publication
(10) Pub. No.: US 2024/0172757 A1
(43) Pub. Date: May 30, 2024

(54) METHOD OF INCREASING SENESCENCE OF A LEGUMINOUS PLANT CROP

(71) Applicant: Ray LOOP, Brownsville, TX (US)

(72) Inventor: Ray LOOP, Brownsville, TX (US)

(21) Appl. No.: 18/375,743

(22) Filed: Oct. 2, 2023

Related U.S. Application Data
(63) Continuation-in-part of application No. 17/488,014, filed on Sep. 28, 2021.
(60) Provisional application No. 63/197,310, filed on Jun. 4, 2021.

(51) Int. Cl. A01N 57/20; A01P 21/00

(52) U.S. Cl. CPC A01N 57/20; A01P 21/00

(57) ABSTRACT

A method of increasing senescence of a leguminous plant crop comprises a step of applying a 2-chloroethylphosphonic acid solution to the leguminous plant during a reproductive growth stage of the crop. Application of the 2-chloroethylphosphonic acid solution significantly reduces the timing of the crop to achieve a harvesting stage, without detrimentally affecting the nutritional value of the leguminous plant crop regardless of increased temperature conditions.

### CLAIM OF PRIORITY

This application is a continuation in part application of and claims priority to pending U.S. patent application Ser. No. 17/488,014 filed Sep. 28, 2021, which claimed priority to U.S. Provisional Application No. 63/197,310 filed Jun. 4, 2021, which are incorporated by reference herein in their entirety.

### TECHNICAL FIELD

The present invention relates generally to a method of treating leguminous plant crops; and more specifically, to a method of treating the crops to increase senescence.

### BACKGROUND OF THE INVENTION

### History of Related Art

Leguminous plant crops are desirable for their high nutritional value including protein and fatty acid. When harvesting legumes, the pods must be allowed to mature and harvested when dry. This waiting period can typically take anywhere from about 39 to 45 days in the R6 stage, which is when beans have accumulated total solids to harvestable moisture, before a harvestable state is reached. Care must also be taken to watch for sudden temperature changes that can affect the health and maturation of the leguminous plant crop. Historically, harvest aids for legumes such as soybeans have been chemistry-based to desiccate the plants to facilitate dry-down. Such aids can require special training and if applied at the wrong time can severely impede yield opportunities, cause lodging or limit potential for use of the crop as a healthy food source.

### SUMMARY

The use of any ripening agent requires chemistry that can shorten time to harvest without affecting quality or quantity produced and not leave undesirable residues. The method described herein provides for the ability to quickly harvest a leguminous plant crop, advantageously shortening plant maturation for harvesting to avoid harsh weather conditions and provide quicker turnaround times without affecting nutritional quality of the crop.

A method of increasing senescence of a leguminous plant crop comprises applying to the crop a solution of 2-chloroethylphosphonic acid during a reproductive growth stage. In some embodiments, the solution is applied at the reproductive growth stage of R5. In other embodiments, the solution is applied at the reproductive growth stage of R6. In other embodiments, the solution is applied during a seed reproductive growth stage preceding a maturity growth stage of R7. Following application, a harvesting stage can be reached at least 10-14 days sooner than without spraying, without substantially altering the desirable nutritional quality or quantity of the leguminous plant crop.

Other aspects, embodiments, and features of this disclosure will become apparent in the following written description.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a graph of crude protein affected by treatment rate of 2-chloroethylphosphonic acid solution according to an embodiment.

FIG. 2 is a graph of crude fat affected by treatment rate of 2-chloroethylphosphonic acid solution according to an embodiment.

FIG. 3 is a graph of crude fiber affected by treatment rate of 2-chloroethylphosphonic acid solution according to an embodiment.

FIG. 4 is a graph of total digestible nutrients affected by treatment rate of 2-chloroethylphosphonic acid solution according to an embodiment.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiments disclosed, but on the contrary, the intention is to cover all modifications, equivalents, and alternatives falling within the spirit and scope of the present application as defined by the appended claims.

### DETAILED DESCRIPTION

The complex juvenile/maturity transition during a leguminous plant's life cycle includes vegetative growth stages and reproductive growth stages. These stages include growth, reproduction, and senescence of fundamental organs of the leguminous plant crop: leaves, flowers, and fruits. By way of example, the growth stages of the soybean will now be described.

Vegetative stages are identified according to the number of fully developed leaves on the main stem; that is, the number of leaves that have all leaflets open and zero undeveloped leaves with leaflet edges still touching. VE is known as the emergence stage and can be characterized by a showing or emergence of the cotyledons and growing point above a soil surface. This is sometimes referred to as a poking through of the plant from the soil. The VE stage may range, for example, anywhere from 5 days after planting to 14 days after planting. The cotyledons (beans) of the plant separate to expose developing unifoliate leaflets. The next vegetative stage is VC, known as the cotyledon stage, wherein two unifoliate leaves are fully developed (with leaf edges no longer touching) while the first trifoliate leaf is not fully developed and its leaflet edges remain touching at this stage. The first trifoliate leaf is fully developed in the V1 stage (1 trifoliate leaf), while the V2 stage (2 trifoliate leaves) contains two fully developed trifoliate leaves and the V3 stage (3 trifoliate leaves) contains 3 fully developed trifoliate leaves. V3 typically occurs 2-3 weeks after VE. V4 to V(n) (four to nth trifoliate leaves are fully developed) then occurs, with the number of leaves determined by factors such as variety of legume and environmental conditions. Typically, herbicides are applied no later than the V3 growth stage.

Reproductive stages are characterized by specific flower, pod, and seed characteristics. R1 is known as the beginning bloom or beginning flowering stage, which has one flower open at any node on the main stem. R2 is referred to as the full bloom or full flowering stage and occurs when a flower on the main stem opens at one of the two top nodes with a fully developed trifoliate leaf. R3, the beginning pod stage, is characterized by a 5 mm ( 3/16 inch) long pod on the main stem at one of the four top nodes with a fully developed trifoliate leaf. This is the stage where typically any last pesticide applications may occur. R4, the full pod stage, can be identified as when a 2 cm (¾ inch) long pod is on the main stem at one of the four top nodes of a fully developed trifoliate leaf. Beginning at R4, environmental stress and/or plant injury can have a great impact on grain yield. R5, the beginning seed stage, is characterized by a 3 mm (⅛ inch) long pod on the main stem at one of the four top nodes that has a fully developed trifoliate leaf. Plant stress at R5 results in aborted seed. R6, the full seed stage, is characterized by green seed filling the pod cavity at one of the four top nodes on the main stem with a fully developed trifoliate leaf. Plant stress at this stage typically produces pod and seed abortion, significantly reducing yields. R7 is known as the beginning maturity stage, wherein one normal pod on the main stem is mature and has turned brown or tan. At this stage, soybean has essentially reached physiologic maturity, meaning the seed has attained maximum dry weight. This stage is also visually identifiable by the start of rapid leaf yellowing. R8 is the fully maturity stage, wherein 95% of pods have turned brown (the mature pod color).

When classifying a crop of soybeans as being at a specific growth stage, at least 50% of the crop must be at or beyond that growth stage. For example, when determining a soybean growth stage, if 15% of the soybean crop is in V2, 55% of the soybean crop is in the V3 stage, and 30% of the soybean crop is classified as V4, then the crop is in the V3 growth stage because 70% of the crop is or has been at or beyond the V3 stage.

Leguminous plant crops as described herein include soybeans, navy beans, kidney beans, pinto beans, black beans and other related bean plant crops, as well as peas, nuts, and lentils. In some embodiments, the leguminous plant is one of: soybeans, navy beans, kidney beans, pinto beans, and black beans.

When treated with a solution of 2-chloroethylphosphonic acid during a reproductive growth stage of the crop, the legumes of a leguminous plant crop are ready for harvest weeks ahead of untreated plants with high quality nutritional value. This acceleration saves time for the crop producer and can save valuable food products when environmental stress to the crop is forecasted. Moreover, application of the solution described herein helps the leguminous plant crop thrive despite any drought conditions or delays to harvesting.

The 2-chloroethylphosphonic acid solution used in the method of the present invention is generally soluble in water and can be applied to plants in aqueous solutions. Aqueous solutions described herein may be partially or wholly composed of water as a suitable liquid medium. However, other liquid mediums may also be used so long as they are non-toxic. Application may be accomplished using conventional equipment known in the art.

The precise amounts of the components of the 2-chloroethylphosphonic acid solution described herein will depend upon the leguminous plant species being treated. By way of example, an amount of about 0.375 pounds of 2-chloroethylphosphonic acid per acre at the R-6 stage has shown significant acceleration of maturation in soybean plants with harvested soybeans having high quality nutritional content. The amount of 2-chloroethylphosphonic acid should be non-phytotoxic with respect to the leguminous plant being treated.

By applying the 2-chloroethylphosphonic acid solution described herein to a leguminous plant when the leguminous plant during a reproductive growth stage, the maturation of the seeds of the leguminous plant is reached quicker than when left untreated. The 2-chloroethylphosphonic acid solution is applied during a reproductive growth stage of at least R5. In some embodiments, application is performed prior to the R7 stage. In some embodiments, the 2-chloroethylphosphonic acid solution is applied during one of: R6 stage and R6.5 stage. By way of example, R6.5 refers to the stage in between R6 and R7. In some cases, maturation is achieved up to 40 days faster than when not treated as described herein, despite high temperature and high humidity environments that can stress the crop and affect nutritional quality.

Full maturity can be achieved within 120 days after seeding. Days to maturity in soybeans are driven by the maturity group. Use of ethephon, discussed below, farmers can advantageously plant a longer maturity group that would generally have greater yield potential and mitigate risk of weather. Thus, harvesting may be done well in advance of the typical 39 to 45 days, saving valuable time and food supply that could be otherwise destroyed or degraded for any number of environmental reasons. Advantageously, as the below results will show, not only does the crop achieve ripening stages surprisingly early but also nutrients of the leguminous plant crop are significantly preserved.

The solution of 2-chloroethylphosphonic acid may be prepared by mixing together 2-chloroethylphosphonic acid (known as ethephon in liquid form and obtainable from a number of sources) with a water solution or a liquid medium that is non-toxic to the particular legume desired. Most commercial sprayers are suitable for preparation and/or application of the solution described herein. To prepare the mixture, during test runs, a tank comprising a capacity of 600 gallons and an agitator was used. Continuous agitation of the mixture during preparation seems to provide best results.

In some embodiments, the 2-chloroethylphosphonic acid solution may comprise a water-soluble urea comprising approximately 46% nitrogen. A dry form of nitrogen may be part of the water solution or it may be part of the 2-chloroethylphosphonic acid solution with suitable mixing. Mixing is performed continuously in certain embodiments. During some test runs, approximately 4 pounds of urea per acre was added to about 10 gallons (83.4 pounds) of water per acre, followed by approximately 1.5 pounds of 2-chloroethylphosphonic acid per acre. In some embodiments, the 2-chloroethylphosphonic acid may also comprise a spreader-sticker. The spreader-sticker may be added, for example, at a rate of 2 ounces (0.125 pounds) per acre and may be silicone-based. A suitable silicone-based spreader-sticker, for example, is Kinetic by Helena. Other non-silicone-based sticker-spreaders may also be used.

In some embodiments, the 2-chloroethylphosphonic acid solution may comprise nitrogen from a nitrogen-containing substance comprising at least about 15% total nitrogen. In some embodiments, the nitrogen-containing substance may also comprise zinc in an amount of up to about 5% zinc.

The composition used in the process described herein is applied to growing plants, as set forth in the examples in this specification. The solution of 2-chloroethylphosphonic acid described herein achieves desirable results when applied during at least an R5 stage of growth. In certain embodiments, the 2-chloroethylphosphonic acid solution is applied during an R6 stage of a leguminous plant crop.

Application of the 2-chloroethylphosphonic acid solution should be performed when the leguminous plant crop comprises at least 50% of the planted crops in the field at a seed growth stage. In some embodiments, the leguminous plant may be at an R5 growth stage when application of the solution described herein is performed. During R5, a fully developed seed pod may comprise, for example, a match-head sized seed in the pod. In some embodiments, the leguminous plant may be at growth stage R5.5, or between R5 and R6 for application. In some embodiments, application is performed when at least 50% of the planted leguminous plant crop is at an R6 reproductive growth stage, as described above. For example, R6 may be visually characterized or identified when at least 50% of the leguminous plant crop comprises at least one seed or “green bean” (in a top pod of the plant) comprising a width equal to its pod cavity. In some embodiments, the leguminous plant may be at growth stage R6.5, or at or between R6 and R7. During some test runs, senescence was achieved within 5 days after application of the solution described herein, with successful harvesting of quality crop. By way of example, prior to application, the physiological stage of the leguminous plant may be determined by inspecting the terminal (or last growing point at the top) end of the leguminous plant crop for a seed pod. Triggering maturation at the R5 growth stage may produce smaller seeds. For commercial production, triggering at R6 may be most successful to obtain more seed at a greater weight.

In some embodiments, the applying step is performed when about 92% of the leguminous plant crop is in the R5 growth stage. In some embodiments, the applying step is performed when 90% of the leguminous plant crop is in the R5.5 growth stage. In some embodiments, the applying step is performed when between 96-98% of the leguminous plant crop is in the R6 growth stage.

In some embodiments, the step of applying a 2-chloroethylphosphonic acid solution comprises directly applying the 2-chloroethylphosphonic acid solution to the foliage and stems of a bean plant. In some embodiments, the step of applying a 2-chloroethylphosphonic acid solution comprises directly applying the 2-chloroethylphosphonic acid solution to the soil in which a bean plant is growing. Direct application may be accomplished, for example, via an irrigation system. In such embodiments, the compound will be root-absorbed to a sufficient extent so as to result in accelerated bean maturation described herein. In some embodiments, the method comprises applying the 2-chloroethylphosphonic acid solution to a bean plant crop at a rate of at least about 0.375 pounds of 2-chloroethylphosphonic acid per acre. Application may also be performed at the rate of up to about 1.5 pounds per acre. Accelerated maturation of a soybean plant has been achieved when applied at the R-6 reproductive growth stage at a rate of about 0.75 pounds of 2-chloroethylphosphonic acid per acre.

Application of the solution described herein may perform best at temperatures below 98° F. In some embodiments, application of the solution is performed at a temperature below about 90° F. Successful test runs, by way of example, described below were performed at 88° F.

During trial runs, soybean plant crops were planted on plot sizes ranging from 25-150 acres. Soybean plant crops were planted on soil used for rotational crops including, for example, grass crop, corn crop, or grain crop. Crops were seeded approximately 1-1.5 inches deep with a twin line planter. No other pretreatments were performed on the soil during test runs. Ground application was performed on raised beds using a flow jet capable of delivering a minimum of 10-20 gallons per acre. Raised beds were used during some test runs. Furrow irrigation was used to water the soybean plant crop, applying water to the top end of each furrow. Using the application as described herein, exceptional field performance in significantly lower time frames than the typical minimum 39-day period, with germination rates as high as 90% and above have been achieved. In some cases, about 30 days have been shaved off waiting times.

During trial applications of the solutions described herein, composition, yield and seed quality was analyzed. It was discovered that even under challenges such as hotter than normal temperatures and drought conditions, the solutions described herein allow for manipulation of the seasons for advantageous harvesting of high quality soybeans. Soybean crop (variety “Linda,” a group 5.6 determinate soybean) was planted in 8-24 row strips following a fall corn crop. Herbicide was applied at 3 pints/acre and crop was fertilized with 20 gallons of 32-0-0 per acre, followed by irrigation as needed. Soil maps indicated two different soil types (Harlingen clay and Olmito clay) in the field that bisected the field, with the second replication having slightly less Olmito clay in the treated area. As they are both components of the other, the field was consistent to visual observation. Crop was observed to be at the R6 stage, comprising “green beans” in top pods of plant characterized by a width equal to the pod cavity. The growth stage of the beans at this point is still very rapid but the dry weight and nutrient accumulation begins to slow in the whole plant by R6.5 which is just 7-10 days later in many cases. Another indicator of the R6 stage is visual signs of senescence in the older leaves of the plants.

Sprayer comprising the 2-chloroethylphosphonic acid solution was prepared and applied as described above at the following rates of Table. 1. Weather conditions at the time of spraying can be found in Table 2.

TABLE 1
Rates of Spray Applications

| | Rate of Setup 65 L | | Spray |
|---|---|---|---|
| | | Lbs | volume |
| Treatment | Pints/Acre | Solution/Acre | Gallons/Acre |
| Control | 0 | 0 | 0 |
| 0.5 | 0.5 | 0.375 | 10 |
| 1 | 1 | 0.75 | 10 |
| 1.5 | 1.5 | 1.125 | 10 |

TABLE 2
Weather conditions at the time of spraying

| Temperature | 88° F. |
|---|---|
| Dewpoint | 79° F. |
| Wind | SSE 11 mph |
| Humidity | 79% |
| Barometric Pressure | 29.94↑ |

The sprayed crops were monitored daily to observe phenotypic changes which included leaf color, leaf drop, pod desiccation, and any visual between treatments. After two days post-spraying, photographs were taken to show the changes in color due to senescense taking place. Table 1 shows the 2-chloroethylphosphonic acid solution at the 0.375 pounds per acre rate on the left and untreated green plants on the right. Table 2 shows the application of the 2-chloroethylphosphonic acid solution at a rate of 0.75 pounds per acre on the left and the 1.125 pounds per acre rate on the right.

Harvest was slightly delayed (about 3 days) due to unavailability of the combine, however, even with this delay, harvested crops were sent for composition and seed quality parameters. The actual harvest during these test runs was well below a soybean moisture content of a market standard 13%. Results showed that waiting for R6 maturity when soybeans have accumulated all the dry matter into the beans, speeding up senescence will decrease time to harvest.

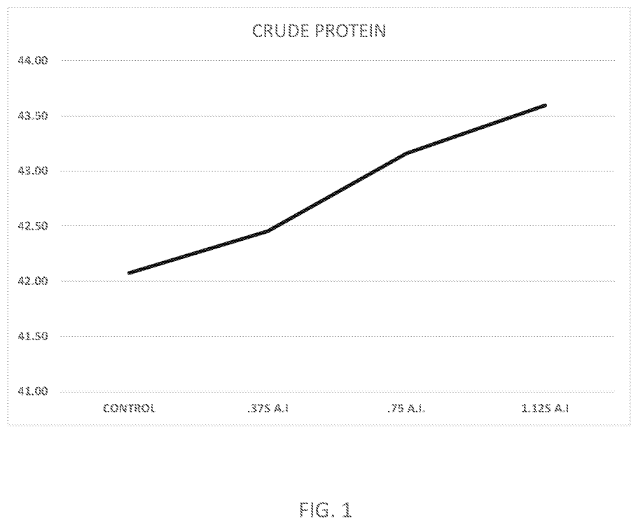

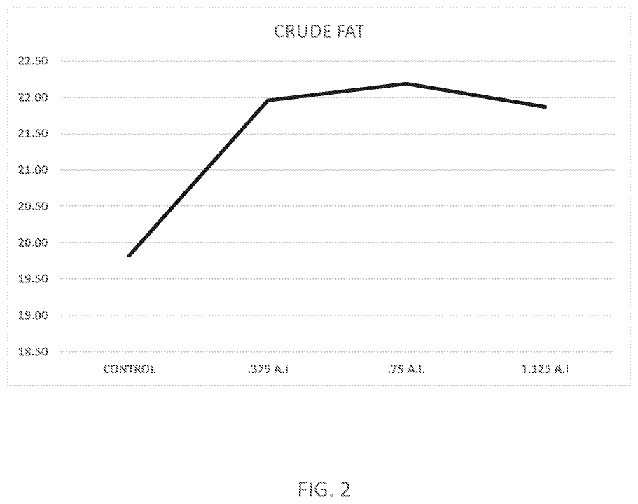

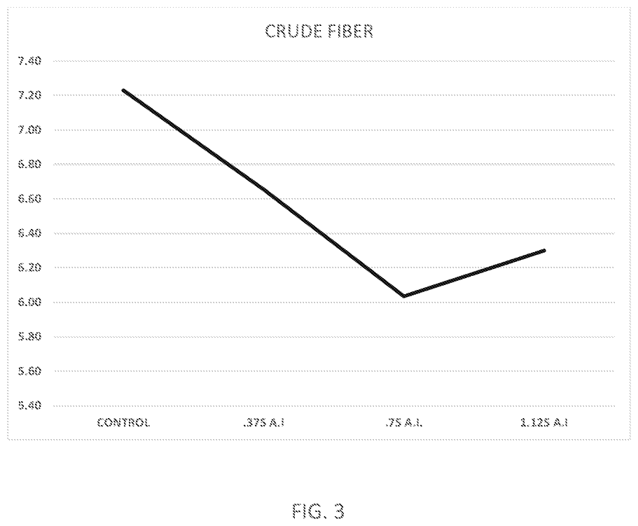

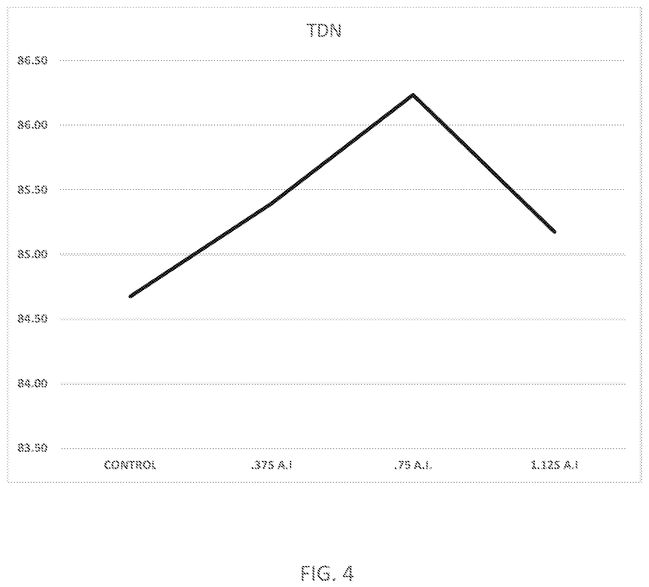

Increasing ethylene levels with the application of the 2-chloroethylphosphonic acid solution also increased some quality parameters of nutritional composition. The 0.75 pounds of the 2-chloroethylphosphonic acid solution per acre rate was highest in crude fat, crude protein, digestible energy and total digestible nutrients (TDN) while being lowest in crude fiber. Ranked behind that in TDN were the 0.375 rate application, followed by the 1.125 rate of application with the untreated being the lowest in TDN. All three treatments improved overall nutrients with some individual components. FIGS. 1 through 4 illustrate major nutritional components affected by treatment rate, where the term “a.i.” is meant to refer to the 2-chloroethylphosphonic acid solution described above. FIG. 1 is a graph of crude protein affected by treatment rate of 2-chloroethylphosphonic acid solution according to an embodiment. FIG. 2 is a graph of crude fat affected by treatment rate of 2-chloroethylphosphonic acid solution according to an embodiment. FIG. 3 is a graph of crude fiber affected by treatment rate of 2-chloroethylphosphonic acid solution according to an embodiment. FIG. 4 is a graph of total digestible nutrients affected by treatment rate of 2-chloroethylphosphonic acid solution according to an embodiment.

As depicted above, the preservation in quality and opportunity for applying the the 2-chloroethylphosphonic acid solution at a reproductive growth stage to control harvest dates around potential weather events also suggests potential for higher quality products from legumes leading to better maintenance of protein quality for human and animal consumption.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount (i.e, 0%) is added in some embodiments.

Unless otherwise specified, all percentages, parts and ratios refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as subsequently indicated as well as to values that are within statistical variations or measuring inaccuracies.

The methods disclosed herein may be suitably practiced in the absence of any element, limitation, compound, or step that is not specifically disclosed herein. Similarly, specific devices described herein may be free of any component not specifically described herein.

While the invention has been particularly shown and described with reference to certain embodiments, it will be understood by those skilled in the art that various changes in form and detail may be made therein without departing from the spirit and scope of the invention.

### ADDITIONAL DESCRIPTION

The following clauses are offered as further description of the disclosed invention.

Clause 1. A method of increasing senescence of a leguminous plant crop, the method comprising applying to the crop of leguminous plant a solution of 2-chloroethylphosphonic acid during a reproductive growth stage wherein at least 50% of the leguminous plant crop is at a reproductive growth stage of at least R5, wherein R5 is a beginning seed growth stage.

Clause 2. The method of any preceding or proceeding claim wherein the R5 reproductive growth stage comprises at least 50% of the leguminous plant crop having about a ⅛ inch-long pod on the main stem at one of the four top nodes that has a fully developed trifoliate leaf.

Clause 3. The method of any preceding or proceeding claim wherein the reproductive growth stage is at R6, wherein R6 is a full seed stage wherein at least 50% of the leguminous plant crop comprises a green seed filling a top pod cavity at one of the four top nodes on a main stem with a fully developed trifoliate leaf, wherein the green seed comprises a width equal to its pod cavity.

Clause 4. The method of any preceding or proceeding claim wherein the reproductive growth stage is a seed growth stage preceding a maturing stage.

Clause 5. The method of any or preceding or proceeding claim comprising a step of harvesting the crop at a moisture content of about 13% within less than about 20 days after spraying.

Clause 6. The method of any preceding or proceeding claim wherein the harvesting step is performed within less than about 18 days after spraying.

Clause 7. The method of any preceding or proceeding claim wherein the harvesting step is performed within less than about 16 days after spraying.

Clause 8. The method of any preceding or proceeding claim wherein the harvested crop comprises a nutritional content of no less than about 43 percent of crude protein.

Clause 9. The method of any preceding or proceeding claim wherein the harvested crop comprises a nutritional content of no less than about 22 percent of crude fat.

Clause 10. The method of any preceding or proceeding claim wherein the step of applying the solution of 2-chloroethylphosphonic acid is performed in environmentally dry conditions comprising less than 0.8 oz/m³ of water.

Clause 11. The method of any preceding or proceeding claim wherein the solution of 2-chloroethylphosphonic acid is applied at a rate of at least about 0.375 pounds per acre.

Clause 12. The method of any preceding or proceeding claim wherein the leguminous plant is a soybean plant.

Clause 13. The method of any preceding claim wherein the leguminous plant comprises foliage and the applying step comprises applying the solution of 2-chloroethylphosphonic acid directly to the foliage of the leguminous plant.

1. A method of increasing senescence of a leguminous plant crop, the method comprising applying to the crop of leguminous plant a solution of 2-chloroethylphosphonic acid during a reproductive growth stage wherein at least 50% of the leguminous plant crop is at a reproductive growth stage of at least R5, wherein R5 is a beginning seed growth stage.

2. The method of claim 1 wherein the R5 reproductive growth stage comprises at least 50% of the leguminous plant crop having about a ⅛ inch-long pod on the main stem at one of the four top nodes that has a fully developed trifoliate leaf.

3. The method of claim 1 wherein the reproductive growth stage is at R6, wherein R6 is a full seed stage wherein at least 50% of the leguminous plant crop comprises a green seed filling a top pod cavity at one of the four top nodes on a main stem with a fully developed trifoliate leaf, wherein the green seed comprises a width equal to its pod cavity.

4. The method of claim 1 wherein the reproductive growth stage is a seed growth stage preceding a maturing stage.

5. The method of claim 1 comprising a step of harvesting the crop at a moisture content of about 13% within less than about 20 days after spraying.

6. The method of claim 5 wherein the harvesting step is performed within less than about 18 days after spraying.

7. The method of claim 5 wherein the harvesting step is performed within less than about 16 days after spraying.

8. The method of claim 5 wherein the harvested crop comprises a nutritional content of no less than about 43 percent of crude protein.

9. The method of claim 5 wherein the harvested crop comprises a nutritional content of no less than about 22 percent of crude fat.

10. The method of claim 1 wherein the step of applying the solution of 2-chloroethylphosphonic acid is performed in environmentally dry conditions comprising less than 0.8 oz/m³ of water.

11. The method of claim 1 wherein the solution of 2-chloroethylphosphonic acid is applied at a rate of at least about 0.375 pounds per acre.

12. The method of claim 1 wherein the leguminous plant is a soybean plant.

13. The method of claim 1 wherein the leguminous plant comprises foliage and the applying step comprises applying the solution of 2-chloroethylphosphonic acid directly to the foliage of the leguminous plant.
